(19) United States
(12) Patent Application Publication
(10) Pub. No.: US 2014/0279015 A1
(43) Pub. Date: Sep. 18, 2014

(54) SHELF-LEVEL MARKETING AND POINT OF SALES ENRICHMENT

(71) Applicant: Locator IP LP, State College, PA (US)

(72) Inventors: Michael R. ROOT, Edmond, OK (US); Steven A. ROOT, Edmond, OK (US)

(21) Appl. No.: 14/218,255

(22) Filed: Mar. 18, 2014

Related U.S. Application Data
(60) Provisional application No. 61/792,983, filed on Mar. 15, 2013.

(51) Int. Cl. G06Q 30/02

(52) U.S. Cl. CPC G06Q 30/0267; G06Q 30/0261
USPC 705/14.58

(57) ABSTRACT

A user's mobile device is located to within a few feet of a specific location in a store or other business. From the user's profile, it is determined whether the user may be interested in a particular product sold in the store. A message is sent to the user's mobile device to lead the user to a position directly in front of the product on the shelf. The message may also include a coupon or other promotional material.

### REFERENCE TO RELATED APPLICATIONS

The present application claims the benefit of U.S. Provisional Patent Application No. 61/792,983, filed Mar. 15, 2013. Related technology that can be used with the invention includes, but is not limited to, that disclosed in the following U.S. patents and patent applications: U.S. Pat. Nos. 6,505,123, 6,754,585, 6,836,730, 6,826,481, 6,988,037, 7,024,310, 6,980,909, 6,985,813, 7,191,065, and 7,289,908, and U.S. patent application Ser. Nos. 10/965,088, 11/035,654, 11/334,898, 11/512,456, 11/710,346, 11/731,933, and 11/838,836. The disclosures of the above patents and patent applications are hereby incorporated by reference in their entireties into the present disclosure.

### FIELD OF THE INVENTION

The present invention is directed to actions affiliated with marketing and advertising using mobile positioning and more particularly to marketing and advertising using mobile positioning to guide a consumer to the specific location of a product in a store.

### DESCRIPTION OF RELATED ART

It is known in the art that marketing and advertising material sent to a user's mobile device (cellular telephone, tablet, or any other similar device capable of data communication) can be tailored to the user's previously stored user profile, the user's location (as determined, e.g., by GPS), or both. Tailoring to the user's location can include one or both of tailoring to the weather at the user's location and advertising businesses near the user's location. The advertising information sent to the user's mobile device can include specific product information, electronic coupons or other special offers.

An example is disclosed in U.S. Pat. No. 7,289,908. Users input user-defined parameters into a consumer information database to disclose their interests. Once the user-defined parameters have been input into the consumer information database, the user-defined parameters can be analyzed by a analysis unit along with weather content identifiers for purposes of targeted marketing. A plurality of vendors can be provided access to the analysis unit. The vendors can independently input search information into the analysis unit for compiling a data set of information which is useful to the vendors for acquiring consumers.

As an example, a vendor who is in the business of selling snow blowers may input a weather content identifier and time identifier into the analysis unit so as to request a list of all user profiles identifying users who resided in spatial locations in the United States which are expected to receive at least 10 inches of snow in the next week. The analysis unit would then compile the data set of all spatial locations in the United States which is expected to receive at least 10 inches of snow in the next week based on at least one weather content identifier, the time identifier, the user profiles and the real-time weather data stored in the weather information database. The data set is then output to the vendor. Based on the data set, the vendor may send advertisements to the consumers (users) who are identified in the data set.

Other examples include determining when a user is near a business of interest and alerting the user through the mobile device that the user is near such a business. The alert can include an electronic coupon or other promotional material.

However, merely directing a user to a business has the following drawbacks. If the targeted marketing material concerns a particular product, such as a product selected in accordance with the user's profile, merely directing the user to a store will not allow the user to locate the product. If the user enters the store and uses a store directory to determine the aisle in which the product is located, the user will be at least as likely to find competing products.

### SUMMARY OF THE INVENTION

A need thus exists in the art to guide users to the specific location for a specific product. It is therefore an object of the invention to meet that need.

To achieve the above and other objects, the present invention is directed to a method comprising (a) automatically determining a location of the mobile communication device; (b) automatically determining interests of the user in accordance with a user profile; and (c) automatically sending the user promotional information in accordance with the location and the interests, the promotional information including a specific location of a specific product. The invention is further directed to a system for implementing such a method.

With the advent of hyper-accurate mobile positioning, it will be possible to locate a user within a few feet of a specific location. As a result, producers will be able to drive/position consumers (users) directly in front of their specific products on shelves at sales outlets.

This will afford the process of providing unique (and before now unavailable) advertising, marketing, and product and service content to a user at the store shelf level (actual point of sale). This process will employ components of the existing technology, e.g., the user's profile and spatial range identifier information.

This takes the level of specificity to a much greater level—that is, to the actual point of sale. Mobile marketing and advertising to the present has not focused upon the exact point of sale at the shelf level. This allows for differentiation between competing products and services between brands, as well as products priced differently from the same provider (allowing for up-selling).

Applications for various embodiments of the present invention include the following:

1) Driving users to purchase products/services based on their profile and specific location within a retail establishment and guiding (directing) the user specifically to the product;

2) Facilitating and accelerating purchases with the aid of buying incentives (coupons, etc.) by capturing the product code off of the specific product's container;

3) A user could capture the product's bar code off of the product container using a camera on the mobile devise and immediately download more information about the product (text, streaming video/audio, instruction manuals, etc.);

4) Such user interest/purchases of products could be used by the producer to track and document sales for inventory replenishment, evaluating marketing campaigns, etc. This would be a more direct measurement of sales data than what may be provided by the store to the product manufacturer (if any).

### BRIEF DESCRIPTION OF THE DRAWINGS

A preferred embodiment will be set forth in detail with reference to the drawings, in which:

FIG. 1 is a block diagram showing a system according to the preferred embodiment;

FIG. 2 is a diagram showing a coordinate system used in the preferred embodiment;

FIG. 3 is a flow chart showing an operation of the system of FIG. 1;

FIG. 4 is a flow chart showing the outputting of individualized output signals according to the preferred embodiment;

FIG. 5 is a set of screen shots illustrating individualized output signals; and

FIG. 6 is a block diagram showing a technique for obtaining more information about a product.

### DETAILED DESCRIPTION OF THE PREFERRED EMBODIMENT

A preferred embodiment will be set forth in detail with reference to the drawings, in which like reference numerals refer to like elements or steps throughout.

Referring now to the drawings and more particularly to FIG. 1 shown therein in block diagram form is one embodiment of the invention in the form of an interactive advisory system constructed in accordance with the present invention. The advisory system 8 is provided with a broadcast network 10 for selectively transmitting individualized output signals to remote communicator devices 11. The broadcast network 10 includes an analysis unit 12, a consumer information database 14, a communicator location database 16, a product location database 21, and a communication network 20.

The analysis unit 12, the consumer information database 14, the communicator location database 16, the product location database 21, and the communication network 20, interrelate and communicate via signal paths 22, 24, 26, 28, 30 and 32. The advisory system 8, the analysis unit 12, the consumer information database 14, the communicator location database 16, and the product location database 21 may be located at the broadcast network 10 or remotely from the broadcast network 10.

The consumer information database 21 includes information regarding consumer preferences. The consumer information database 21 may be populated in any suitable fashion. For example, a user may be asked to supply information concerning consumer preferences or the like when registering for the service. The consumer preference information may be supplemented with data on actual consumer choices, purchases, and/or product interactions as is done with loyalty programs at grocery stores. The consumer information database 21 may also include consumer preference information received from third party sources such as other stores, credit monitoring agencies, etc. The consumer information database 21 may also include consumer preference information derived from customer demographic information, location data, internet browsing history, etc.

The consumer information database 14 contains data representative of at least one user-defined parameter correlated to each one of a plurality of users. In one version of the present invention, each of the user-defined parameters includes various information related to output signals, such as a spatial range identifier, a user profile, one or more time identifiers for identifying particular times or time intervals that a user may desire an output product, a spatial location fixed or dynamic code, and a spatial location identifier for identifying particular spatial locations of interest to the user if the spatial location fixed or dynamic code indicates that the spatial location is to be fixed. The user profile in each of the user-defined parameters includes at least a user identifier code for identifying a particular communicator device 11 associated with a particular user.

For instance, the user identifier code could be a mobile telephone number identifying one of the communicator devices 11, which in this instance could be a mobile telephone or a pager, for example. The time identifier desirably could be a computer code for identifying the particular time, times, or time intervals the user desires the advisory system 8 to communicate output signals to the user. The spatial location identifier 26 could be a computer code identifying a particular predetermined spatial location such as, by way of example but not limitation, a longitude and latitude anywhere in the world, a town, a county, a township, address, zip code, altitude and combinations thereof.

As discussed above, the spatial location identifier identifies a particular spatial location anywhere in the world and/or altitude above sea level. The spatial range identifier identifies a particular spatial range surrounding the spatial location identifier. Each of the users can select the spatial location identifier and the spatial range identifier so as to receive one or more output signals for the spatial location identified by the spatial location identifier, and within the spatial range identified by the spatial range identifier.

For example, referring to FIG. 2, shown therein is a coordinate system illustrating four spatial location identifiers and four spatial range identifiers associated with different users of the present invention. That is, a first user selects the spatial location identifier X1, Y1, Z1 (or the analysis unit 12 identifies that a communicator device 11 associated with the first user is located at the spatial location X1, Y1, Z1), and the first user selects a spatial range identifier R1 (or the analysis unit 12 associates the spatial range identifier R1 with the first user). A second user selects the spatial location identifier X2, Y2, Z2 (or the analysis unit 12 identifies that a communicator device 11 associated with the second user is located at the spatial location X2, Y2, Z2), and the second user selects the spatial range identifier R2 (or the analysis unit 12 associates the spatial range identifier R2 with the second user).

The first user associated with the spatial location identifier X1, Y1, Z1 and the spatial range identifier R1 will receive output signals based on the spatial range identified by the spatial location identifier X1, Y1, Z1 and the spatial range identifier R1, as well as information regarding the first user stored in the consumer information database 21. The second user associated with the spatial location identifier X2, Y2, Z2 and the spatial range identifier R2 will receive output signals based on the spatial range identified by the spatial location identifier X2, Y2, Z2 and the spatial range identifier R2, as well as information regarding the second user stored in the consumer information database 21. Likewise, users associated with the spatial location identifiers X3, Y3, Z3 and X4, Y4, Z4 and the spatial range identifiers R3 and R4 will receive output signals based on the spatial range identified by the spatial location identifiers X3, Y3, Z3, X4, Y4, Z4, the spatial range identifier R3, R4, and information regarding the users stored in the consumer information database 21.

The magnitudes of the spatial range identifiers R1, R2, R3 and R4 can be different or the same. In addition, the magnitudes of the spatial range identifiers R1, R2, R3 and R4 can vary widely and are desirably selected by the users or determined by the analysis unit 12. By way of example but not limitation, the spatial range identifiers can vary based upon what products or services the consumer (user) desires to purchase, which can be selected by the user or provided automatically by the analysis unit.

Referring again to FIG. 1, the product location database 21 includes information regarding the location of products or services within a retail store or marketing area. The product location may be a general location, such as information directing a consumer to a specific store within a geographic location, shopping district, mall, etc. The product location may more specific such as a specific location within a store, a specific aisle, a specific side of an aisle, a specific location along an aisle, etc. The product location may be three dimensional, including the specific shelf or height of the product along with the aisle, side of the aisle, and/or location along the aisle.

The product location database 21 may be input and/or updated by a store or group of stores.

The communicator location database 16 is an optional feature of the present invention, and is enabled via the signal paths 26 and 22. The communicator location database 16 is updated—for example automatically, repeatedly, and/or continuously—such that the communicator location database 16 contains real-time or near-real-time data indicative of the spatial locations of the communicator devices 11. In one embodiment, the user identifier code in the user profile is transmitted to the communicator location database 16 via the signal path 22. The communicator location database 16 desirably receives data from the communicator devices 11 identified by the user identifier codes via at least one of a variety of possible resources such as a mobile phone network, a mobile phone network equipped with the wireless application protocol technology, global positioning satellite (GPS) technology, the Internet, LORAN technology, radar technology, transponder technology or any other type of technology capable of tracking the spatial location of a communicator device 11 and communicating the location of such communicator device 11 to the communicator location database 16. Preferably, the communicator location database 16 is updated automatically and in real- or near-real time, as to the location of each of the communicator devices 11, such as by the wireless application protocol technology. Alternatively, the communicator location database 16 may be updated upon demand of a user as to the location of each of the communicator devices 11, such as by the wireless application protocol technology.

The communication network 20 can be, by way of example but not limitation, a mobile phone network, a mobile phone network with wireless application protocol technology, the Internet, a facsimile network, a satellite network (one or two-way), a RF radio network, or any other means of transmitting information from a source to an end user.

The communicator devices 11 may be bidirectional or unidirectional communicator devices. The communicator devices 11 can be, by way of example but not limitation, a portable device, such as a mobile telephone, a smart phone, a pager, a laptop computer or a personal digital assistant, or any other electronic device capable of receiving information. Furthermore, the communicator device 11 can be incorporated into an object that is utilized or accessible by the user, such as a helmet, an automobile, or an airplane, for example. While only three communicator devices 11 are represented in FIG. 1 for purposes of illustration, the interactive advisory system 8 contemplates the utilization of a large number of communicator devices 11.

The analysis unit 12 receives the data in the consumer information database 14, the communicator location database 16, and the product location database 21 from the signal paths 24, 26, and 28. The analysis unit 12 can be, by way of example but not limitation, a computer desirably programmed to automatically and continuously compare the data in the consumer information database 14, communicator location database 16, and product location database 21 so as to generate an individualized output signal.

The individualized output signal may include promotional information. The promotional information may include a specific location of a product or service. The location of the product or service may be within the spatial range identified by the spatial range identifier for each user-defined parameter in the consumer information database 14. The output signals may be output to the communication network 20 via the signal path 32 for transmittal to a communicator device 11 associated with a user.

The analysis unit 12 gathers the product location data from the product location database 21.

The communication network 20 receives the output signals and the user identification codes via the signal paths 32 and 30. In response thereto, the communication network 20 transmits the individualized output signals to the communicator devices 11 associated with the user identification codes via the signal paths 34a, 34b and 34c, such that each user receives the individualized output information requested.

The signal paths 34a, 34b and 34c refer to any suitable communication link, which permits electronic communications. For example, the signal paths 34a, 34b and 34c can be point-to-point shared and dedicated communications, infrared links, microwave links, telephone links, CATV links, satellite and radio links and fiber optic links.

The individualized output signal may be an audio, video, textural and/or graphical data signal. For example, the individualized output signal can be a .WAV file or other suitable file containing an animated representation of a real or hypothetical individual speaking an individualized message to the user.

The signal paths 22, 24, 26, 28, 30 and 32 can be logical and/or physical links between various software and/or hardware utilized to implement the present invention. It should be understood that each of the signal paths 22, 24, 26, 28, 30 and 32 are shown and described separately herein for the sole purpose of clearly illustrating the information and logic being communicated between the individual components of the present invention. In operation, the signal paths may not be separate signal paths but may be a single signal path. In addition, the various information does not necessarily have to flow between the components of the present invention in the manner shown in FIG. 1. For example, although FIG. 1 illustrates the user identifier code being transmitted directly from the consumer information database 14 to the communication network 20 via the signal path 30, the user identifier code can be communicated to the analysis unit 12 via the signal path 24 and then communicated to the communication network 20 via the signal path 32.

Once the consumer information has been input into the consumer information database 14, the consumer information can be analyzed by the analysis unit 12 for purposes of targeted marketing and advertising. A plurality of vendors 36 can be provided access to the analysis unit 12 via a plurality of signal paths 38a, 38b, and 38c. The vendors 36 can independently input search information into the analysis unit 12 for compiling a data set of information, which is useful to the vendors 36.

The broadcast network 10, the analysis unit 12, and/or the vendor 36a-c may determine the appropriate size of the spatial range identifier. Alternatively, the spatial range identifier can be determined by the nature of the individualized output signal.

It is envisioned that consumers (users) will subscribe to the services provided by the broadcast network 10. In that regard, the broadcast network 10 may or may not charge a service fee to the users and/or to the vendors 36a-c. Alternatively, the service may be provided to consumers by a retail store, shopping district, or mall. In addition, some services may be provided by the broadcast network 10 for one charge and additional services may be provided at an enhanced charge.

To save processing power, the analysis unit 12 may periodically determine which communicator devices 11 are turned off or out of range. Once this has been determined, the analysis unit 12 would then not generate any individualized output signals for the communicator devices 11 which are turned off or out of range. Once a particular one of the communicator devices 11 is turned on or comes within range, the analysis unit 12 would then attempt to generate individualized output signals for such communicator devices 11. In other words, to save processing power the analysis unit 12 may only generate individualized output signals for the communicator devices 11 which are active and within range.

The analysis unit 12 can be located at the broadcast network 10. Alternatively, the analysis unit 12 can be separate from the remainder of the broadcast network 10 and provided as a service to the broadcast network 10.

In another preferred embodiment, rather than or in addition to the user providing consumer information to the consumer information database 14, the consumer information database 14 is programmed to provide a plurality of pre-defined consumer profiles with each of the pre-defined consumer profiles directed to an activity designated by the user. The activity can be a business, personal or recreational need.

Referring now to FIG. 3, shown therein is another embodiment of an advisory system 8b constructed in accordance with the present invention. The advisory system 8b includes one or more communicator devices 11, an optional prioritization unit 95, at least one service provider 90 and one or more vendors 102. Three vendors are shown in FIG. 3 and designated with the reference numerals 102a, 102b and 102c for purposes of clarity. The communicator devices 11, the service provider(s) 90, and the prioritization unit 95 are similar in construction and function to the communicator devices 11 and the service provider(s) 90, as discussed above. It should be understood that while only three communicator devices 11 are represented in FIG. 3 for purposes of illustration, the advisory system 8b contemplates the utilization of a large number of communicator devices 11.

Each communicator device 11 is preferably portable and utilized or accessible by a user. In a preferred embodiment, each user has a user profile stored in a consumer information database 100, similar to the consumer information database 14 illustrated with reference to FIG. 1. The consumer information database 100 can be a single database or a distributed database. In either case, the consumer information database 100 can be maintained by the service provider 90, one or more of the vendors 102 or a third party. In addition, the service provider 90 and each of the vendors 102 can have their own consumer information database and such information for each user can be consolidated or searched to provide the functions described hereinafter.

The advisory system 8b is designed to provide targeted marketing and/or advertising information to a plurality of users. The users are typically located remotely from the service provider 90, but will typically be in close proximity, e.g., within several hundred feet of the vendor 102. That distance may vary based upon the geographical layout of vendor 102. In general, the user profiles within the consumer information database 100 are automatically updated with information regarding the likes/dislikes of the users based on their own current and/or historical conduct. Each of the user profiles within the consumer information database 100 typically includes a user identifier code identifying a communicator device 11 associated with a particular user.

The consumer information database 100 can either be originated by the service provider 90 or originated by one or more of the vendors 102 or one or more third parties. The consumer information database 100 is updated by the service provider 90 and/or the plurality of vendors 102 based upon the user's conduct. For example, the service provider 90 can create the user profile in the consumer information database 100 by analyzing the user's responses to information received. In one embodiment, the user's communicator device 11 can be web-enabled and the service provider 90 can update the user's user profile based on information entered into the communicator device 11 as the communicator device 11 is used to access web sites on the Internet to determine the user's likes and dislikes.

The plurality of vendors 102 can create or update the consumer information database 100 of the user's likes or dislikes based on the user's buying habits, or the user's past or present location(s) within a marketing area, such as the vendor's store or sales outlet or sales outlets of multiple vendors that are in close proximity (such as an enclosed or open shopping mall); or the user's past or present location(s) relative to a vendor's store or sales outlet, or the stores or sales outlets of multiple vendors that are in close proximity (such as a shopping mall). The marketing area can be essentially any size and such size can depend upon a variety of factors such as type of product or service, cost of product or service or the like. Typically, the marketing area will encompass a township, that is, approximately 6-7 miles across, but could be a small as a single vendor's store, or a shopping mall.

The present location of the communicator device 11 and thus, the user, can be automatically monitored using a communicator location database as described above, and/or the communicator device 11 can provide its own location to the service provider 90 and/or one of the vendors 102 or a third party. The location of the communicator device 11 can be determined using any suitable system or technology. For example, satellite-positioning technology, such as GPS, can be incorporated into the communicator device 11 or a triangulation technology such as the WAP protocol can be used by the service provider 90. Additionally, position sensors (typically mounted at known locations) may be placed in or in close proximity to a store by the vendors 102 or the service provider 90 (or a third party) to refine the location of the communicator device 11 and thus, the user. For example, GPS technology known as wide area augmentation (WMS), or local area augmentation can be utilized for determining the position of the communicator device 11 within several feet of its actual location. Refining the location of the user enables the service provider 90 and the vendors 102 to more accurately determine the shopping habits of the user by monitoring the location of the communicator devices 11 (and thus the users) within or near the store or stores within the marketing area.

The vendors 102 and/or a third party at their direction, can optionally maintain a database of information directed to specific product locations within the marketing area, e.g., specific goods in certain aisles and/or shelves within certain aisles. The user's location (determined indirectly by monitoring the location of the user's communicator device 11) within the marketing area as well as the time of the user at any particular location can then be correlated with the information indicative of product locations within the marketing area to determine which products or services the user is looking at within the marketing area.

The service provider(s) 90 and the vendor(s) 102 may separately or jointly analyze the user profile information accumulated and stored in the consumer information database 100. This analysis enables each of the service provider 90 and/or each vendor 102 to pass targeted marketing information, such as advertisement, promotional and coupon content to at least one communicator device 11. The user profile information may also be provided to a third party for marketing various products and services to the user. The advertisement, promotional and coupon content may have a purchase inducement, such as a discount code or a bar code used for communicating a discount or promotion code to the vendor 102. However, the discount or promotion code can be used in other manners, such as by receiving discounts from the service provider 90, or crediting the user's credit card, debit card or bank account. When a purchase is made, the discount or promotion code can be provided to one of the vendor's checkout terminals via any suitable manner (such as a docking station, wireless communication, scanning a barcode on the screen of the communicator device 11, or by typing the promotion code into the checkout terminal), the vendor 102 can update the user's user profile and such update can be used for providing the discount or promotion, or the checkout terminal can communicate with the communicator device 11 or the service provider 90 to indicate that the discount or promotion was used.

Also, the content may be provided by at least one or more vendor(s) providing identical content or different content. In addition, priority may be assigned to the content based upon the vendor providing such content.

The vendors 102 can be provided with any suitable computer systems for implementing the functionality of the vendors 102 described herein. For example, the vendors 102 can each be provided with a store system computer and one or more checkout terminals. The store system computers receive buying habit information and update the user profiles 100 based on the user's conduct monitored by the vendors 102 as discussed above. The store system computers of the vendors 102 can also provide the targeted marketing information to the service provider 90 so that the service provider 90 can forward such targeted marketing information to the communicator devices 11.

In one example of the system 8b, a user having one of the communicator devices 11 walks into a store of a home improvement chain and purchases a lawn mower. A store computer at the home improvement chain updates the consumer information database 100 for the user and the type of product purchased. The next time the user walks into one of the stores for the home improvement chain, the service provider 90 sends the communicator device 11 of the user an advertisement of a product or service related to the user's prior purchase, such as trash bags or engine oil or replacement parts or a tune-up for the lawn mower.

In another example of the system 8b, the user having the communicator device 11 walks into the store of the home improvement chain after he had purchased the lawn mower and browses particular types of plants. The vendor, i.e., the home improvement chain having a store system monitoring the location of the user's communicator device 11 within the store and the time spent at various locations within the store correlates the location of the user's communicator device 11 with information of product locations within the store and sends a signal to the service provider 90 to provide a text message, graphic image, or audio message of a coupon for the particular type of plant to the communicator device 11 of the user.

The user decides to purchase the particular type of plant using the coupon, and on his way to the checkout terminal walks through the part of the store where replacement parts for the user's lawn mower are presented. The store system computer correlates the information in the user's user profile indicating that a lawn mower was purchased with the user's location within the store and the information regarding the location of products within the store and passes a coupon or other promotional item to the user's communicator device 11 for a new blade for the lawn mower. The user receives the coupon or promotion for the new blade, selects a new blade and proceeds to the checkout terminal. Then, discount codes for the plant and the new blade are entered into the checkout terminal to provide a discount for the user. Thus, the plant and the mower blade are sold and delivered to the user at the store using the discount codes for the plant and the mower blade.

In another example of the system 8b, the user having the communicator device 11 comes into close proximity of a number of stores or sales outlets of multiple vendors (such as a shopping mall). The vendors each having a store monitoring system as described above can detect the location of the user's communicator device 11 in close proximity to its store or sales outlet. Having determined that the user has made purchases in the store or sales outlet before, the vendor can send a signal to the service provider 90 to provide a text message, graphic image, or audio message to the user's communicator device 11 to induce the use to enter its store or sales outlet, instead of the store or sales outlet of one of the other vendors. As described above, priorities can be assigned to the vendors by the service provider(s) 90, the vendors or by the user.

In another example of the system 8b, the user having the communicator device 11 comes into close proximity of a number of stores or sales outlets of multiple vendors (such as a shopping mall). The vendors each having a store monitoring system as described above can detect the location of the user's communicator device 11 in close proximity to its store or sales outlet. Having determined that the user has recently entered a housewares store of another vendor, one of the vendors offering housewares products sends a signal to the service provider 90 to provide a text message, graphic image, or audio message to the user's communicator device 11 offering promotions or discounts on housewares products. As described above, priorities can be assigned to the vendors by the service provider(s) 90, the vendors or by the user.

FIG. 4 is a flowchart illustrating a method of outputting individualized output signals according to a preferred embodiment.

A user registers for the service in step 202. Consumer preference information is determined in step 204. A user location in determined in step 206. The user location may be proximate to or within a retail store or marketing area. In step 208, promotional material is generated and output. The promotional material may be individualized for a specific user based on the user location and/or the user consumer preference information associated with the user. If the user purchases the product or service after receiving the promotional material, the consumer preference information associated with the user is updated in step 210. Regardless of whether the user purchases the product or service, the marketing campaign may be evaluated in step 212 based on whether the user purchased the product or service.

FIG. 5 illustrates examples of individualized output signals or promotional material output by the advisory system 8 or 8b.

For example, the analysis unit 12 may, at the request of a vendor 36a, output an individualized output signal including promotional material for the vendor 36a to all users within a spatial range identifier R1 of the vendor 36a. The promotional material may include a location of a vendor 36a as shown, for example, in FIG. 4(a)

In another example, the analysis unit 12 may, at the request of a vendor 36b, output an individualized output signal including promotional material for the vendor 36b to all female users between the ages of 26 and 56 within a retail store. The promotional material may the location of the vendor's product such as a specific aisle of a store as shown, for example, in FIG. 5(b).

In another example, the analysis unit 12 may, at the request of a vendor 36c, output an individualized output signal including promotional material for the vendor 36b to all user's with Internet browsing behavior indicating a preference for whole grains. The promotional material may the location of the vendor's product such as a specific portion of a specific aisle within a store as shown, for example, in FIG. 5(c).

In another example, the analysis unit 12 may, at the request of the vendor 36c, output an individualized output signal including promotional material for the vendor 36b to all user's within a specific distance of the vendor's product within a retail store. The promotional material may the location of the vendor's product such as a specific portion of a specific aisle within a store as shown, for example, in FIG. 5(d).

FIG. 6 shows a technique in which a user can obtain more information on a product. The user can use a camera 601 in the communicator device 11 to capture the product's bar code (or QR code or similar code) 603 off of the product container 605 and immediately download more information 607 about the product (text, streaming video/audio, instruction manuals, etc.) to the communicator device 11.

While a preferred embodiment has been set forth above, those skilled in the art who have reviewed the present disclosure will readily appreciate that other embodiments can be realized within the scope of the invention. For example, not all disclosed steps have to be performed. Therefore, the invention should be construed as limited only by the appended claims.

We claim:

1. A method for marketing and advertising to a consumer (user) who is using a mobile communication device, the method comprising:
(a) automatically determining a location of the mobile communication device near or within a place of business;
(b) automatically determining interests of the user in accordance with a user profile; and
(c) automatically sending the user promotional information in accordance with the location and the interests, the promotional information including a specific location of a product within the place of business.

2. The method of claim 1, wherein the promotional information comprises a buying incentive for the product.

3. The method of claim 2, wherein the buying incentive comprises a coupon.

4. The method of claim 1, wherein the mobile communication device comprises a camera, and further comprising:
(d) receiving image information relating to the product taken with the camera; and
(e) sending additional information relating to the product to the mobile communication device in accordance with the image information.

5. The method of claim 4, wherein the image information comprises an image of a code on the product.

6. The method of claim 4, wherein the additional information comprises an instruction manual.

7. The method of claim 4, wherein the additional information comprises text.

8. The method of claim 4, wherein the additional information comprises streaming audio or video material.

9. The method of claim 1, further comprising determining whether the user buys the product.

10. The method of claim 9, further comprising accumulating sales data for at least one of inventory replenishment and evaluation of marketing campaigns.

11. A system for marketing and advertising to a consumer (user) who is using a mobile communication device, the system comprising:
a communication device for automatically determining a location of the mobile communication device near or within a place of business; and
a processing device, in communication with the communication device, for:
automatically determining interests of the user in accordance with a user profile; and
automatically sending the user promotional information in accordance with the location and the interests, the promotional information including a specific location of a product within the place of business.

12. The system of claim 11, wherein the processing device is configured such that the promotional information comprises a buying incentive for the product.

13. The system of claim 12, wherein the processing device is configured such that the buying incentive comprises a coupon.

14. The system of claim 11, wherein the processing device is configured to operate with the mobile communication device when the mobile communication device comprises a camera and is further configured for:
(d) receiving image information relating to the product taken with the camera; and
(e) sending additional information relating to the product to the mobile communication device in accordance with the image information.

15. The system of claim 14, wherein the processing device is configured such that the image information comprises an image of a code on the product.

16. The system of claim 14, wherein the processing device is configured such that the additional information comprises an instruction manual.

17. The system of claim 14, wherein the processing device is configured such that the additional information comprises text.

18. The system of claim 14, wherein the processing device is configured such that the additional information comprises streaming audio or video material.

19. The system of claim 11, wherein the processing device is further configured for determining whether the user buys the product.

20. The system of claim 19, wherein the processing device is further configured for accumulating sales data for at least one of inventory replenishment and evaluation of marketing campaigns.
